(19) United States
(12) Patent Application Publication
(10) Pub. No.: US 2024/0079735 A1
(43) Pub. Date: Mar. 7, 2024

(54) ELECTRODE TAB AND BATTERY

(71) Applicant: Huizhou Huawo Technology Co., Ltd., Huizhou (CN)

(72) Inventors: Zhiwei Chen, Huizhou (CN); Kaicheng Lin, Huizhou (CN); Xulin Ye, Huizhou (CN); Jing Guo, Huizhou (CN)

(21) Appl. No.: 17/974,808

(22) Filed: Oct. 27, 2022

(30) Foreign Application Priority Data
Sep. 7, 2022 (CN) 202222377261.8

(51) Int. Cl. H01M 50/534; H01M 50/536

(52) U.S. Cl. CPC H01M 50/534; H01M 50/536

(57) ABSTRACT

The present invention relates to electrode tabs and batteries. The electrode tab includes a first metal strip and a metal connector connected to the first metal strip. A melting point of the metal connector is lower than a melting point of the first metal strip, or a solidus temperature of the metal connector is lower than a solidus temperature of the first metal strip, or a liquidus temperature of the metal connector is lower than a liquidus temperature of the first metal strip. The electrode tab has the advantages of regular shape, which are not only easy to install and assemble, saving assembly costs, but also not easy to be damaged in the process of assembly, transportation and storage. The electrode tab does not affect an overall size of the battery, is more suitable for use in scenarios such as small miniature batteries and power batteries.

### CROSS-REFERENCE TO RELATED APPLICATION

The present application claims priority of China Patent Application No. 202222377261.8, filed on Sep. 7, 2022 which is incorporated herein by reference.

### BACKGROUND OF THE INVENTION

### 1. Technical Field

The present invention relates to the technical field of batteries, in particular to electrode tabs and batteries.

### 2. Description of Related Art

Many digital products do not have a short-circuit protection circuit, and cannot protect the battery very well. If the circuit of the product fails, it is easy to cause external short-circuit of the battery. Once the battery is short-circuited, it is easy to cause fire and explosion, resulting in casualty and property loss.

At present, in the industry, the electrode tabs are mainly to play a bridge role in communication between the inside and outside of the battery. With the development of batteries, battery capacity and charge-discharge current are increasing, and the safety requirements of battery are increasing. For example, SJ-T 11796-2022 “General Specification for Lithium-Ion Batteries and Battery Packs for Electronic Cigarettes”, safety test 7.1 high-temperature external short circuit, requires that the fully charged battery is heated to 57° C.±4° C. (degree Celsius), and then the positive and negative terminals of the battery are connected with lead wires, so as to ensure that the total external resistance is not greater than 20 mΩ (milliohms). The battery shall not fire or explode as a result of the test.

In the prior art, the internal resistance of the battery is reduced by adjusting the formulation of the positive and negative electrode materials of the battery, which is smaller than the external conductor to meet the short-circuit test. Since the performance of the positive and negative electrode materials of the battery has reached the limit, it is difficult for such a solution to meet the increasingly stringent safety requirements, which also results in that the existing batteries in the industry cannot pass the above-mentioned short-circuit test, and the phenomenon of fire generally exists.

China patent application No. 201520975623.0 (Pub. No. CN205194769U) discloses an electrode tab with overcurrent protection, and describes that the electrode tab is provided with a PTC material between a first metal strip and a second metal strip, the first metal strip and the second metal strip being electrically connected by the PTC material. The drawbacks and disadvantages of this patent are as follows.

Firstly. PTC is a positive temperature coefficient thermistor, its internal resistance is larger than the internal resistance of the battery and thus can't meet the high-power discharge requirements of the battery.

Secondly, the power density of PTC is low, while, in order to meet the high-power discharge, a larger volume of PTC is required, which will occupy equipment and battery space.

Thirdly, PTC, as a protective component, is expensive to manufacture which requires manufacturers and consumers to bear the cost and has a poor cost performance ratio.

An electrode tab with an overcurrent self-breaking function is disclosed in the China patent application No. 201520977646.5 (Pub. No. CN205543011U), which describes that the conductive part of the electrode tab is narrowed by punching in the middle part of the metal sheet of the electrode tab, and when a large current caused by a short circuit passes through both sides of the through-hole, the electrode tab can blow in time, so as to protect the battery. The drawbacks and disadvantages of this patent are as follows.

Firstly, punching in the middle part of the electrode tab band is a destructive design, which may cause structural damage to the electrode tab band, and the bending and breaking phenomenon may easily occur during the production and use by the downstream manufacturers, so that the battery cannot be used and is not convenient for assembly and transportation.

Secondly, the size of the punching determines the overcurrent capacity of the electrode tab, and it is necessary to accurately calculate the aperture to ensure that the battery performance is not lost, which is not conducive to the standardized production.

Thirdly, when the performance of the battery of the client is contrary to the self-interrupting function, it's hard to choose which function shall be retained.

Existing technology does not add a reliable, standardizable short-circuit protection function to a battery without changing the physical dimensions of the existing battery, which need to be improved.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is a structural view of an electrode tab in accordance with a first embodiment of the present invention, dashed lines show an inner structure which is covered by an outer structure of the electrode tab.

FIG. 2 is a cross-sectional view of the electrode tab and an enlarged view of a part of the electrode tab in accordance with the first embodiment of the present invention.

FIG. 3 is a structural view of an electrode tab in accordance with a variation embodiment of the first embodiment of the present invention, dashed lines show an inner structure which is covered by an outer structure of the electrode tab.

FIG. 4 is a perspective view of a battery in accordance with a second embodiment of the present invention.

FIG. 5 is an exploded view of the battery in accordance with the second embodiment of the present invention, dashed lines illustrate a part of hidden structural lines which are covered by frontal surfaces of the battery.

FIG. 6 is a perspective view of a battery in accordance with a third embodiment of the present invention.

FIG. 7 is an exploded view of the battery in accordance with the third embodiment of the present invention, dashed lines illustrate a part of hidden structural lines which are covered by frontal surfaces of the battery.

FIG. 8 is a perspective view of a battery in accordance with a fourth embodiment of the present invention.

FIG. 9 is an exploded view of the battery in accordance with the fourth embodiment of the present invention, dashed lines illustrate a part of hidden structural lines which are covered by frontal surfaces of the battery.

FIG. 10 is a perspective view of a battery in accordance with a fifth embodiment of the present invention.

FIG. 11 is an exploded view of the battery in accordance with the fifth embodiment of the present invention, dashed lines illustrate a part of hidden structural lines which are covered by frontal surfaces of the battery.

FIG. 12 is a perspective view of a battery in accordance with a sixth embodiment of the present invention.

FIG. 13 is an exploded view of the battery in accordance with the sixth embodiment of the present invention, dashed lines illustrate a part of hidden structural lines which are covered by frontal surfaces of the battery.

FIG. 14 is a perspective view of a battery in accordance with a seventh embodiment of the present invention.

FIG. 15 is an exploded view of the battery in accordance with the seventh embodiment of the present invention, dashed lines illustrate a part of hidden structural lines which are covered by frontal surfaces of the battery.

FIG. 16 is a perspective view of a battery in accordance with an eighth embodiment of the present invention.

FIG. 17 is an exploded view of the battery in accordance with the eighth embodiment of the present invention, dashed lines illustrate a part of hidden structural lines which are covered by frontal surfaces of the battery.

### DETAILED DESCRIPTION OF THE INVENTION

The invention will now be described in detail through several embodiments with reference to the accompanying drawings.

For the purpose of clarity of description, many practical details will be described together in the following description. It should be understood, however, that these practical details are not intended to limit the present invention. That is to say, in some embodiments of the present invention, these practical details are unessential. Moreover, for simplification of the drawings, some customary and conventional structures and components will be depicted in a simple schematic manner in the drawings.

Besides, descriptions such as “first”, “second”, if involved in the present invention, are merely for descriptive purpose, but should not particularly refer to order or subsequence, and are not used to limit the present invention, and they are merely used for distinguishing components or operations described by the same technical term, but should not be construed as indicating or implying importance in the relativity or suggesting the number of a related technical feature. Thus, defining a feature with “first” or “second” may explicitly or implicitly mean that at least one such feature is included. In addition, the technical solutions of various embodiments may be combined with each other, but must be based on the fact that they can be realized by a person of ordinary skill in the art. When the combinations of the technical solutions contradict each other or cannot be realized, it should be considered that such combinations of the technical solutions do not exist, and are beyond the scope of protection claimed in the present invention.

### First Embodiment

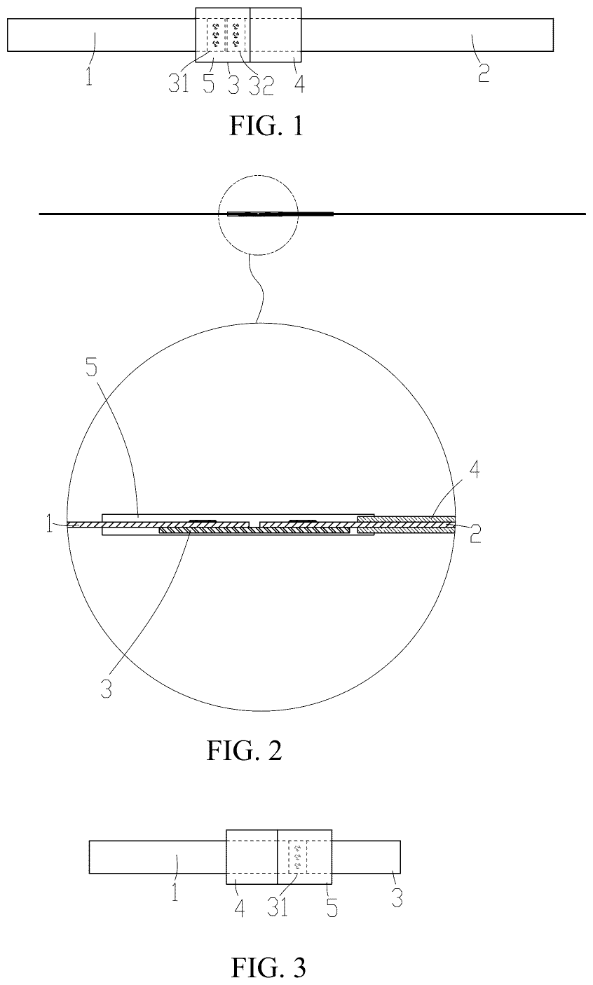

The first embodiment provides an electrode tab, please refer to FIGS. 1 and 2, the electrode tab includes a first metal strip 1, a second metal strip 2, a metal connector 3, a tab glue tape 4 and a reinforcing structure 5. The metal connector 3 is used for connecting the first metal strip 1 and the second metal strip 2 and physically separating the first metal strip 1 and the second metal strip 2. That is, one end of the metal connector 3 is connected to one end of the first metal strip 1, and the other end of the metal connector 3 is connected to one end of the second metal strip 2. There is a space between the two ends of the first metal strip 1 and the second metal strip 2.

The reinforcing structure 5 is used to increase a structural strength of a connection 32 between the metal connector 3 and the second metal strip 2, and a structural strength of a connection 31 between the metal connector 3 and the first metal strip 1. The reinforcing structure 5 may include a tab glue tape or a seal belt for common sealing, the tab glue tape or the seal belt is wrapped on the connections 31 and 32. By wrapping the connections 31, 32, the function of protecting the connections 31, 32 can be achieved, and the structural strength of the connections can be strengthened, so that the connections can endure a stronger pull-out force.

The tab glue tape 4 is used for covering at least a part of the second metal strip 2 to prevent the second metal strip 2 from piercing the battery pack/case and the battery separator, avoiding causing the core to be short-circuited. The tab glue tape 4 is also used for immediate hot sealing a sealing opening of a pack/case of the battery. The tab glue tape 4 is high temperature resistance and electrolyte corrosion resistance; and preventing the internal resistance of the battery from increasing. The reinforcing structure 5 may also wrap a portion of the tab glue tape 4 to increase the structural strength of the second metal strip 2.

In practical applications, the second metal strip 2 is used for electrically connecting with a core of a battery. The first metal strip 1 is used for electrically connecting with a load of the battery. The tab glue tape 4 is used to cover a part of the second metal strip 2 and the ultrasonic welding joints of the core and the second metal strip 2. A part of the second metal strip 2 covered by the tab glue tape 4 is clamped in the seal of the battery pack/case. The first metal strip 1, the metal connector 3 (wrapped by the reinforcing structure 5) and a part of the second metal strip 2 (covered by the tab glue tape 4) are exposed to the outside of the battery pack/case. The other part of the second metal strip 2 is accommodated in the battery pack/case. The battery pack/case may be a metallic (e.g., steel, stainless steel, aluminum) cylindrical can, a plastic box, of a foil (e.g., metallized foil) pouch, or the like.

The material of the first metal strip 1 and the second metal strip 2 may be chosen from, but not limited to, copper, copper plating nickel, nickel, aluminum, stainless steel, iron, silver, etc.

The metal connector 3 satisfies one of the following characteristics: (1) its melting point is lower than that of the first metal strip 1 and the second metal strip 2; (2) its solidus temperature is lower than that of the first metal strip 1 and the second metal strip 2; (3) its liquidus temperature is lower than that of the first metal strip 1 and the second metal strip 2. That is, the metal connector 3 has a characteristic of low melting temperature. The material of the metal connector 3 may be selected from, but not limited to, tin, tin alloys, aluminum, aluminum alloys, wood's alloys, indium tin alloys, bismuth tin alloys, according to different requirements of melting temperature.

When short circuit occurs in a circuit including the electrode tab in the present invention, the metal connector 3 may be melted immediately, acting as a fuse-link, disconnecting the circuit, thus a battery in the circuit is protected from the short circuit. In the embodiment, both the first metal strip and the metal connector are in sheet shape. Thus, the metal connector 3 has a small size, and a size of the electrode tab in the present invention may be almost the same as that of a traditional electrode tab which has no short circuit protecting function. That is, the electrode tab in the embodiment has no effect on an external dimension of a battery and is suitable for all kinds of batteries, especially for small and miniature batteries. Because of the reinforcing structure 5, the electrode tab is not easy to be directly affected by external forces and is not easy to break.

Therefore, the batteries having the electrode tab have the advantages of regular shape, which are not only easy to install and assemble, saving assembly costs, but also not easy to be damaged in the process of assembly, transportation and storage. This electrode tab can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

In addition, the metal connector 3 has lower resistivity and lower internal resistance than PTC, MOSFET, TCO and other short circuit protection devices. In the embodiment, and a DC impedance range of the metal connector 3 is 0.5-5 mΩ (milliohm). The first metal strip 1, the second metal strip 2 and the metal connector 3 are all metal thin plates with a thickness of about 0.1 mm (millimetre), the seal belt (the reinforcing structure 5) has a thickness of about 0.1 mm and the tab glue tape 4 has a thickness of about 0.1 mm, and a maximum thickness of the electrode tab may be controlled within 0.4 mm due to the thin plate-shape of each part of the structure.

As described above, in the present embodiment, the metal connector 3 may be selected from, but not limited to, tin, a tin alloy, aluminum, an aluminum alloy, wood's alloy, and an indium tin alloy. According to different product requirements, melting temperature can be adjusted by adjusting a ratio of different metals. Owing to the rheological properties of the alloy, different alloy compositions have different liquidus temperature characteristics, which can realize precise temperature control. The adjustable range of melting temperature includes, but not limited to, 47° C.-300° C. A large current flowing through the first metal strip 1 and the second metal strip 2 generates self-heating, and when the heating temperature is greater than the melting temperature, the metal connector 3 is fused to play a safety protection role.

In this embodiment, the metal connector 3 is connected to the first metal strip 1 and the second metal strip 2 in a manner including, but not limited to, laser welding, ultrasonic welding, resistance welding, HOTBAR welding, and conductive adhesive bonding.

In the present embodiment, the tab glue tape 4 is made by a substrate with glue selected from, but not limited to, DNP black glue, embossed white glue, PP glue, Teflon, et al. The tab glue tape 4 covers and wraps the second metal strip 2 by heat sealing. The structural strength of the tab can be effectively enhanced by wrapping with the tab glue tape 4.

Note that in the present embodiment, the reinforcing structure 5 is a seal belt made by a substrate with glue selected from, but not limited to, DNP black glue, embossed white glue, PP glue, Teflon glue, et al. The seal belt wraps the connection region of the metal connector 3 with the first metal strip 1 and the second metal strip 2 by heat sealing, and the heat sealing temperature of the seal belt is lower than the heat sealing temperature of the tab glue tape 4. The structural strength of the connection region can be effectively enhanced by wrapping with the seal belt. Owning to the wrapping with the seal belt, the welding position (connection region) can be folded 180 degrees in half≥5 times without breaking, ensuring that the downstream manufacturer does not break it during production and use.

This electrode tab may be widely used in the fields of lithium-ion batteries, sodium ion batteries, chemical batteries and secondary batteries.

### Variation Embodiment of the First Embodiment

FIG. 3 illustrates a structural view of an electrode tab in accordance with a variation embodiment of the first embodiment of the present invention. The electrode tab in the variation embodiment only includes the first metal strip 1, the metal connector 3, the tab glue tape 4 and the reinforcing structure 5. The second metal strip 2 is omitted. One end of the metal connector 3 is connected to one end of the first metal strip 1. The reinforcing structure 5 may include a tab glue tape or a seal belt for common sealing, the tab glue tape or the seal belt is wrapped on the connection 31 between the metal connector 3 and the first metal strip 1. The tab glue tape 4 is used for covering at least a part of the second metal strip 2 to prevent the second metal strip 2 from piercing the battery pack/case and the battery separator, avoiding causing the core to be short−circuited. The tab glue tape 4 is also used for immediate hot sealing a sealing opening of a pack/case of the battery. The tab glue tape 4 is wrapped on the first metal strip 1. The reinforcing structure 5 may also wrap a portion of the tab glue tape 4 to increase the structural strength of the first metal strip 1.

In practical applications, the other ends of the first metal strip 1 and the metal connector 3 are used for electrically connecting with the core of the battery and the load of the battery, respectively. A part of the first metal strip 1 covered by the tab glue tape 4 is clamped in the seal of the battery pack/case. The metal connector 3 and the reinforcing structure 5 may be exposed to the outside of the battery pack/case, or may be accommodated in the battery pack/case.

The metal connector 3 satisfies one of the following characteristics: (1) its melting point is lower than that of the first metal strip 1; (2) its solidus temperature is lower than that of the first metal strip 1; (3) its liquidus temperature is lower than that of the first metal strip 1. The material of the metal connector 3 may be selected from, but not limited to, tin, tin alloys, aluminum, aluminum alloys, wood's alloys, indium tin alloys, bismuth tin alloys, according to different requirements of melting temperature.

When short circuit occurs in a circuit including the electrode tab in the present invention, the metal connector 3 may be melted immediately, acting as a fuse-link, disconnecting the circuit, thus a battery in the circuit is protected from the short circuit. In the embodiment, both the first metal strip and the metal connector are in sheet shape. Thus, the metal connector 3 has a small size, and a size of the electrode tab in the present invention may be almost the same as that of a traditional electrode tab which has no short circuit protecting function. That is, the electrode tab in the embodiment has no effect on an external dimension of a battery and is suitable for all kinds of batteries, especially for small and miniature batteries. Because of the reinforcing structure 5, the electrode tab is not easy to be directly affected by external forces and is not easy to break.

Therefore, the batteries having the electrode tab have the advantages of regular shape, which are not only easy to install and assemble, saving assembly costs, but also not easy to be damaged in the process of assembly, transportation and storage. This electrode tab can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

### Second Embodiment

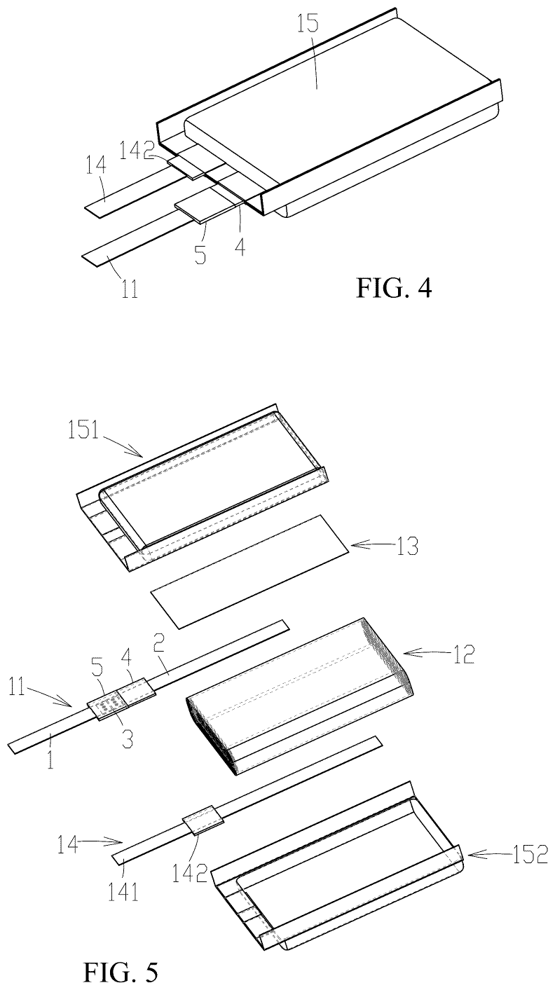

Please refer to FIGS. 4 and 5, a battery having a square shape in accordance with a second embodiment of the present invention is illustrated. The battery at least includes a first electrode tab 11, a second electrode tab 14, a core 12, a termination tape 13, and a pack 15. The first electrode tab 11 has the same structure as that in the first embodiment. The second electrode tab 14 includes a rectangular metal sheet 141 and a tab glue tape 142 wrapped on and covering a part of the rectangular metal sheet, and is a common battery tab. The material of the first metal strip 1 and the second metal strip 2 of the first electrode tab 11 may be chosen from, but not limited to, copper, copper plating nickel, nickel, aluminum, stainless steel, iron, silver, etc. The material of the rectangular metal sheet 141 of the second electrode tab 14 may be chosen from, but not limited to, copper, copper plating nickel, nickel, aluminum, stainless steel, iron, silver, etc.

The core 12 may include a positive electrode plate, a first separator, a negative electrode plate and a second separator which are stacked one by one then rolled into a jellyroll. The positive electrode plate may include a metal sheet, e.g., aluminum foil, upon which positive electrode material or electrode active mix spread in conventional manner. The negative electrode plate may include a metal sheet, e.g., copper foil, upon which negative electrode material or electrode active mix spread in conventional manner. The pack 15 is the case of the battery, includes an upper cover 151 and a lower cover 152 connected to the upper cover to form a receiving space, and is made of aluminum plastic film in the embodiment. A liquid electrolyte may be filled in the pack 15 to provide ionic conductivity. The liquid electrolyte generally includes an electrolytic salt dissolved in a solvent, i.e. an inorganic solvent or an organic solvent. In other embodiments, solid electrolyte, or polymer or gel electrolyte may be used to replace the liquid electrolyte.

The termination tape 13 is attached to a surface of the core 12. The termination tape 13 is an insulating tape and is at least used to prevent the core 12 from being unwound. The first electrode tab 11 is connected to one of the positive electrode plate and the negative electrode plate of the core 12, and the second electrode tab 14 is connected to the other one of the positive electrode plate and the negative electrode plate of the core 12. A part of the second electrode tab 14 and a part of the tab glue tape 142 protrude out of the pack 15, and the other part of the tab glue tape 142 is clamped in the seal of the pack 15 or received in the pack 15. The first metal strip 1, the metal connector 3 (wrapped by the reinforcing structure 5) and a part of the second metal strip 2 (wrapped by the tab glue tape 4) protrude out of the pack 15, and the tab glue tape 4 is clamped in the seal of the pack 15. In this embodiment, the battery is a square battery with the two electrode tabs 11, 14 leading from the same side.

Compared with the traditional plug-in modes of PTC and TCO, the battery has the advantages of regular shape, which are not only easy to install and assemble, saving assembly costs, but also not easy to be damaged in the process of assembly, transportation and storage. The first electrode tab 11 can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

The shape and size of the battery of the present invention have no visible difference from the shape and size of a conventional battery, but the short circuit protection function of melting is realized, which is safe, reliable and highly practical.

### Third Embodiment

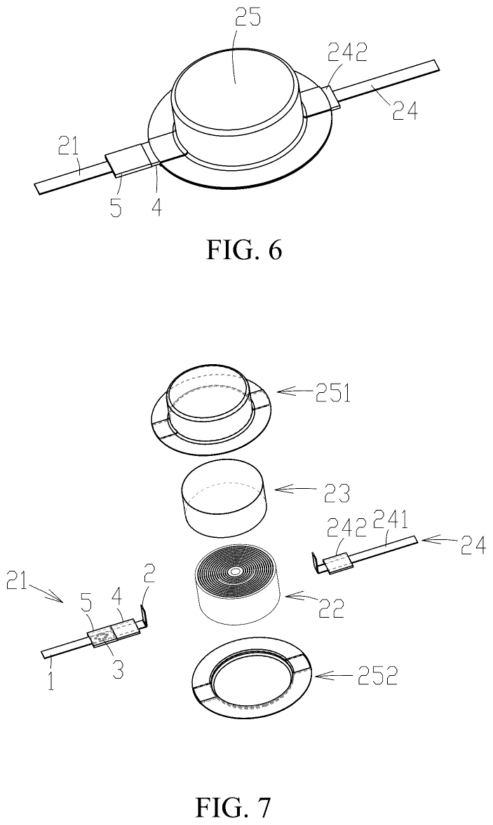

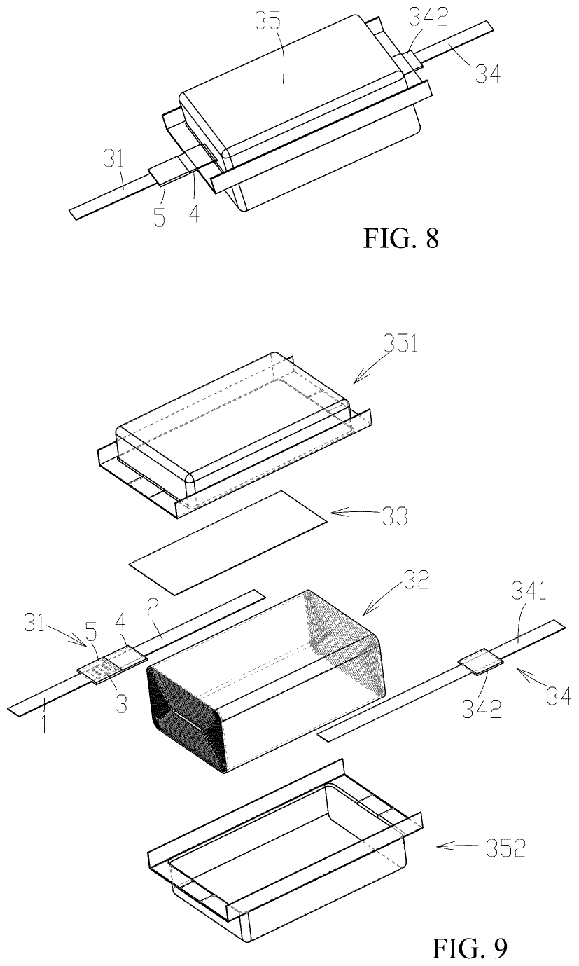

Please refer to FIGS. 6 and 7, a battery having a button shape in accordance with a third embodiment of the present invention is illustrated. The battery at least includes a first electrode tab 21, a second electrode tab 24, a core 22, a termination tape 23, and a pack 25. The first electrode tab 21 has the same structure as that in the first embodiment. The second electrode tab 24 includes a rectangular metal sheet 241 and a tab glue tape 242 wrapped on and covering a part of the rectangular metal sheet, and is a common battery tab. The material of the first metal strip 1 and the second metal strip 2 of the first electrode tab 21 may be chosen from, but not limited to, copper, copper plating nickel, nickel, aluminum, stainless steel, iron, silver, etc. The material of the rectangular metal sheet 241 of the second electrode tab 24 may be chosen from, but not limited to, copper, copper plating nickel, nickel, aluminum, stainless steel, iron, silver, etc.

The core 22 may include a positive electrode plate, a first separator, a negative electrode plate and a second separator which are stacked one by one then rolled into a jellyroll. The positive electrode plate may include a metal sheet, e.g., aluminum foil, upon which positive electrode material or electrode active mix spread in conventional manner. The negative electrode plate may include a metal sheet, e.g., copper foil, upon which negative electrode material or electrode active mix spread in conventional manner. The pack 25 is the case of the battery, includes an upper cover 251 and a lower cover 252 connected to the upper cover to form a receiving space, and is made of aluminum plastic film in the embodiment. A liquid electrolyte may be filled in the pack 25 to provide ionic conductivity. The liquid electrolyte generally includes an electrolytic salt dissolved in a solvent, i.e. an inorganic solvent or an organic solvent. In other embodiments, solid electrolyte, or polymer or gel electrolyte may be used to replace the liquid electrolyte.

The termination tape 23 is attached to a surface of the core 22. The termination tape 23 is an insulating tape and is at least used to prevent the core 22 from being unwound. The first electrode tab 21 is connected to one of the positive electrode plate and the negative electrode plate of the core 22, and the second electrode tab 24 is connected to the other one of the positive electrode plate and the negative electrode plate of the core 22. A part of the second electrode tab 24 and a part of the tab glue tape 242 protrude out of the pack 25, and the other part of the tab glue tape 242 is clamped in the seal of the pack 25 or received in the pack 25. The first metal strip 1, the metal connector 3 (wrapped by the reinforcing structure 5) and a part of the second metal strip 2 (wrapped by the tab glue tape 4) protrude out of the pack 25, and the tab glue tape 4 is clamped in the seal of the pack 25. In this embodiment, the battery is a button battery with the two electrode tabs 21, 24 leading from two opposite sides of the battery.

Compared with the traditional plug-in modes of PTC and TCO, the battery has the advantages of regular shape, which are not only easy to install and assemble, saving assembly costs, but also not easy to be damaged in the process of assembly, transportation and storage. The first electrode tab 21 can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

The shape and size of the battery of the present invention have no visible difference from the shape and size of a conventional battery, but the short circuit protection function of melting is realized, which is safe, reliable and highly practical.

### Fourth Embodiment

Please refer to FIGS. 8 and 9, a battery having a square shape in accordance with a fourth embodiment of the present invention is illustrated. The battery at least includes a first electrode tab 31, a second electrode tab 34, a core 32, a termination tape 33, and a pack 35. The first electrode tab 31 has the same structure as that in the first embodiment. The second electrode tab 34 includes a rectangular metal sheet 341 and a tab glue tape 342 wrapped on and covering a part of the rectangular metal sheet, and is a common battery tab. The material of the first metal strip 1 and the second metal strip 2 of the first electrode tab 31 may be chosen from, but not limited to, copper, copper plating nickel, nickel, aluminum, stainless steel, iron, silver, etc. The material of the rectangular metal sheet 341 of the second electrode tab 34 may be chosen from, but not limited to, copper, copper plating nickel, nickel, aluminum, stainless steel, iron, silver, etc.

The core 32 may include a positive electrode plate, a first separator, a negative electrode plate and a second separator which are stacked one by one then rolled into a jellyroll. The positive electrode plate may include a metal sheet, e.g., aluminum foil, upon which positive electrode material or electrode active mix spread in conventional manner. The negative electrode plate may include a metal sheet, e.g., copper foil, upon which negative electrode material or electrode active mix spread in conventional manner. The pack 35 is the case of the battery, includes an upper cover 351 and a lower cover 352 connected to the upper cover to form a receiving space, and is made of aluminum plastic film in the embodiment. A liquid electrolyte may be filled in the pack 35 to provide ionic conductivity. The liquid electrolyte generally includes an electrolytic salt dissolved in a solvent, i.e. an inorganic solvent or an organic solvent. In other embodiments, solid electrolyte, or polymer or gel electrolyte may be used to replace the liquid electrolyte.

The termination tape 33 is attached to a surface of the core 32. The termination tape 33 is an insulating tape and is at least used to prevent the core 32 from being unwound. The first electrode tab 31 is connected to one of the positive electrode plate and the negative electrode plate of the core 32, and the second electrode tab 34 is connected to the other one of the positive electrode plate and the negative electrode plate of the core 32. A part of the second electrode tab 34 and a part of the tab glue tape 342 protrude out of the pack 35, and the other part of the tab glue tape 342 is clamped in the seal of the pack 35 or received in the pack 35. The first metal strip 1, the metal connector 3 (wrapped by the reinforcing structure 5) and a part of the second metal strip 2 (wrapped by the tab glue tape 4) protrude out of the pack 35, and the tab glue tape 4 is clamped in the seal of the pack 35. In this embodiment, the battery is a square battery with the two electrode tabs 31, 34 leading from two opposite sides of the battery.

Compared with the traditional plug-in modes of PTC and TCO, the battery has the advantages of regular shape, which are not only easy to install and assemble, saving assembly costs, but also not easy to be damaged in the process of assembly, transportation and storage. The first electrode tab 31 can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

The shape and size of the battery of the present invention have no visible difference from the shape and size of a conventional battery, but the short circuit protection function of melting is realized, which is safe, reliable and highly practical.

### Fifth Embodiment

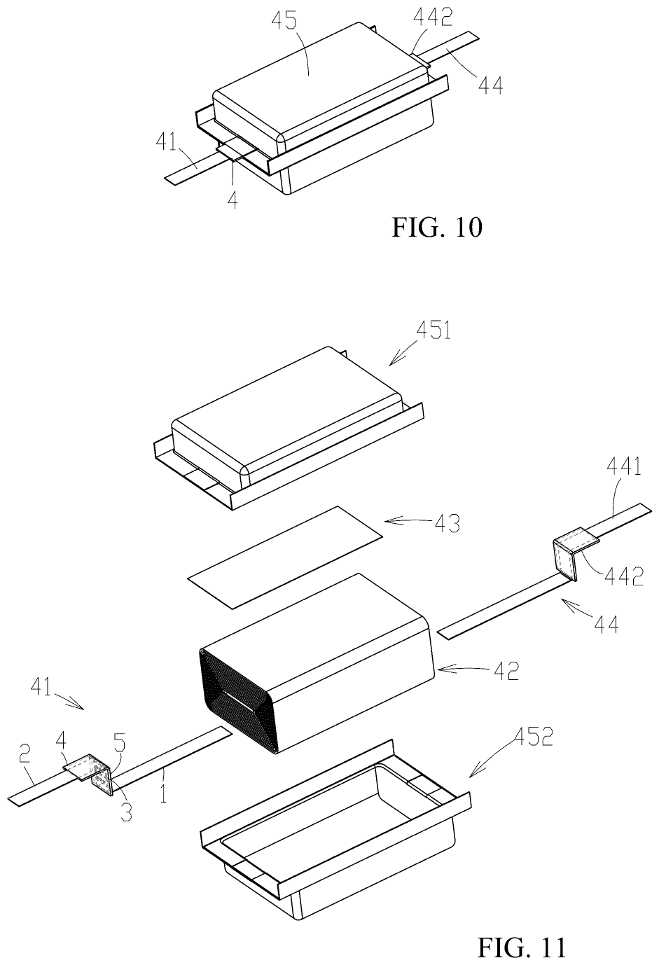

Please refer to FIGS. 10 and 11, a battery having a square shape in accordance with a fifth embodiment of the present invention is illustrated. The battery at least includes a first electrode tab 41, a second electrode tab 44, a core 42, a termination tape 43, and a pack 45. The first electrode tab 41 has the same structure as that in the first embodiment. The second electrode tab 44 includes a rectangular metal sheet 441 and a tab glue tape 442 wrapped on and covering a part of the rectangular metal sheet, and is a common battery tab.

The core 42, the pack 45, the termination tape 43, and the second electrode tab 44 have the same structures as those of the core 32, the pack 35, the termination tape 33 in the fourth embodiment. The difference between the fourth embodiment and the fifth embodiment includes: (1) both the first electrode tab 41 and the second electrode tab 44 are bent at two places; (2) the first metal strip 1 of the first electrode tab 41 is connected to one of the positive electrode plate and the negative electrode plate of the core 42, and the second metal strip 2 is used to connect with a load of the battery; (3) most importantly, the first metal strip 1, the metal connector 3 (wrapped by the reinforcing structure 5) and a part of the second metal strip 2 (wrapped by the tab glue tape 4) are received in the pack 45, and only a part of the second metal strip 2 and a part of the tab glue tape 4 protrude out of the pack 45. Therefore, the metal connector 3 which is relatively vulnerable is protected with high strength, so that its reliability is better.

Compared with the traditional plug-in modes of PTC and TCO, the battery has the advantages of regular shape, which are not only easy to install and assemble, saving assembly costs, but also not easy to be damaged in the process of assembly, transportation and storage. The first electrode tab 41 can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

The shape and size of the battery of the present invention have no visible difference from the shape and size of a conventional battery, but the short circuit protection function of melting is realized, which is safe, reliable and highly practical.

### Sixth Embodiment

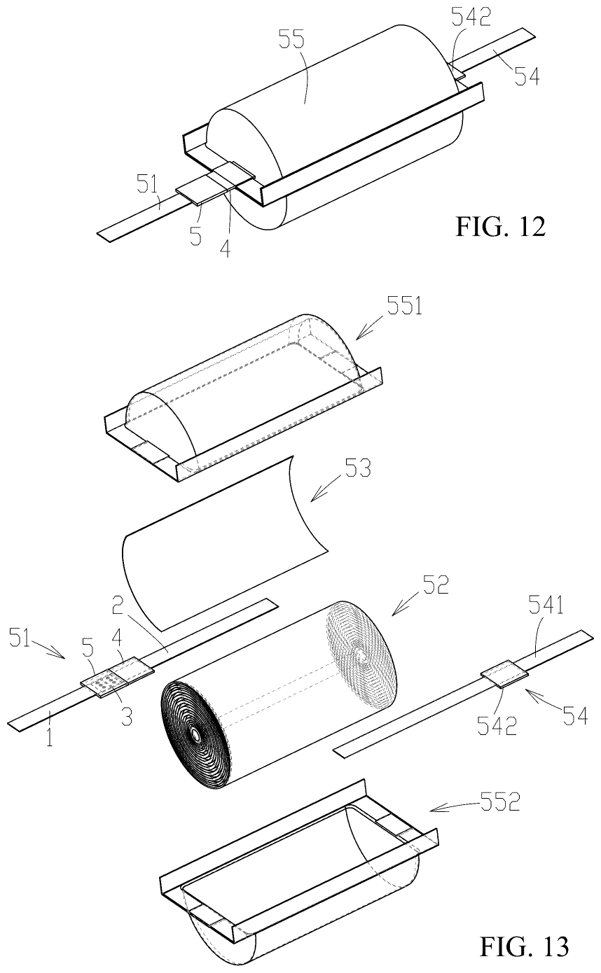

Please refer to FIGS. 12 and 13, a battery having a cylindrical shape in accordance with a sixth embodiment of the present invention is illustrated. The battery at least includes a first electrode tab 51, a second electrode tab 54, a core 52, a termination tape 53, and a pack 55. The first electrode tab 51 has the same structure as that in the first embodiment. The second electrode tab 54 includes a rectangular metal sheet 541 and a tab glue tape 542 wrapped on and covering a part of the rectangular metal sheet, and is a common battery tab. In this embodiment, the battery is a cylindrical battery with the two electrode tabs 51, 54 leading from two opposite sides of the battery. The material of the first metal strip 1 and the second metal strip 2 of the first electrode tab 51 may be chosen from, but not limited to, copper, copper plating nickel, nickel, aluminum, stainless steel, iron, silver, etc. The material of the rectangular metal sheet 541 of the second electrode tab 54 may be chosen from, but not limited to, copper, copper plating nickel, nickel, aluminum, stainless steel, iron, silver, etc.

The core 52 may include a positive electrode plate, a first separator, a negative electrode plate and a second separator which are stacked one by one then rolled into a jellyroll. The positive electrode plate may include a metal sheet, e.g., aluminum foil, upon which positive electrode material or electrode active mix spread in conventional manner. The negative electrode plate may include a metal sheet, e.g., copper foil, upon which negative electrode material or electrode active mix spread in conventional manner. The pack 55 is the case of the battery, includes an upper cover 551 and a lower cover 552 connected to the upper cover to form a receiving space, and is made of aluminum plastic film in the embodiment. A liquid electrolyte may be filled in the pack 55 to provide ionic conductivity. The liquid electrolyte generally includes an electrolytic salt dissolved in a solvent, i.e. an inorganic solvent or an organic solvent. In other embodiments, solid electrolyte, or polymer or gel electrolyte may be used to replace the liquid electrolyte.

The termination tape 53 is attached to a surface of the core 52. The termination tape 53 is an insulating tape and is at least used to prevent the core 52 from being unwound. The first electrode tab 51 is connected to one of the positive electrode plate and the negative electrode plate of the core 52, and the second electrode tab 54 is connected to the other one of the positive electrode plate and the negative electrode plate of the core 52. A part of the second electrode tab 54 and a part of the tab glue tape 542 protrude out of the pack 55, and the other part of the tab glue tape 542 is clamped in the seal of the pack 55 or received in the pack 55. The first metal strip 1, the metal connector 3 (wrapped by the reinforcing structure 5) and a part of the second metal strip 2 (wrapped by the tab glue tape 4) protrude out of the pack 55, and the tab glue tape 4 is clamped in the seal of the pack 55.

Compared with the traditional plug-in modes of PTC and TCO, the battery has the advantages of regular shape, which are not only easy to install and assemble, saving assembly costs, but also not easy to be damaged in the process of assembly, transportation and storage. The first electrode tab 51 can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

The shape and size of the battery of the present invention have no visible difference from the shape and size of a conventional battery, but the short circuit protection function of melting is realized, which is safe, reliable and highly practical.

### Seventh Embodiment

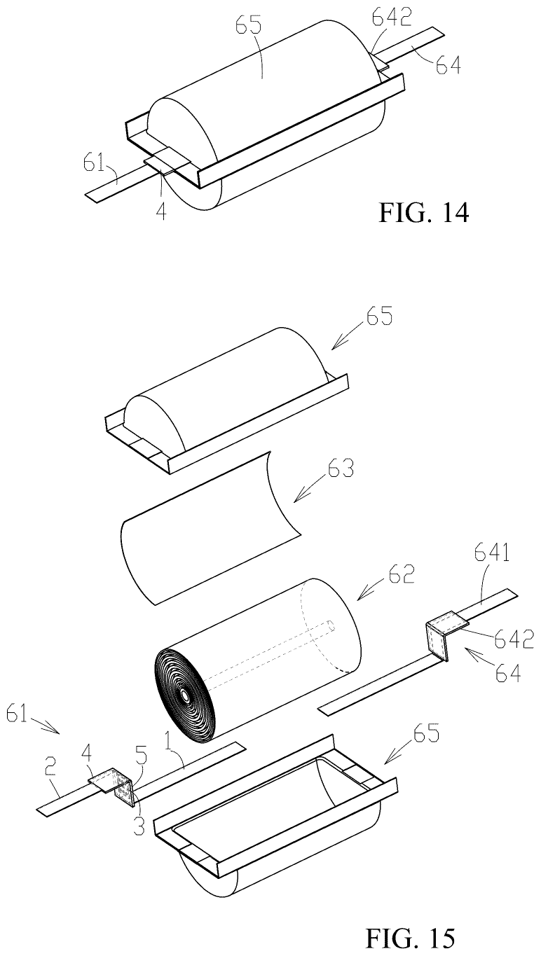

Please refer to FIGS. 14 and 15, a battery having a cylindrical shape in accordance with a seventh embodiment of the present invention is illustrated. The battery at least includes a first electrode tab 61, a second electrode tab 64, a core 62, a termination tape 63, and a pack 65. The first electrode tab 61 has the same structure as that in the first embodiment. The second electrode tab 64 includes a rectangular metal sheet 641 and a tab glue tape 642 wrapped on and covering a part of the rectangular metal sheet, and is a common battery tab. In this embodiment, the battery is a cylindrical battery with the two electrode tabs 61, 64 leading from two opposite sides of the battery.

The core 62, the pack 65, the termination tape 63, and the second electrode tab 64 have the same structures as those of the core 52, the pack 55, the termination tape 53 in the sixth embodiment. The difference between the sixth embodiment and the seventh embodiment includes: (1) both the first electrode tab 61 and the second electrode tab 64 are bent at two places; (2) the first metal strip 1 of the first electrode tab 61 is connected to one of the positive electrode plate and the negative electrode plate of the core 62, and the second metal strip 2 is used to connect with a load of the battery; (3) most importantly, the first metal strip 1, the metal connector 3 (wrapped by the reinforcing structure 5) and a part of the second metal strip 2 (wrapped by the tab glue tape 4) are received in the pack 65, and only a part of the second metal strip 2 and a part of the tab glue tape 4 protrude out of the pack 65. Therefore, the metal connector 3 which is relatively vulnerable is protected with high strength, so that its reliability is better.

Compared with the traditional plug-in modes of PTC and TCO, the battery has the advantages of regular shape, which are not only easy to install and assemble, saving assembly costs, but also not easy to be damaged in the process of assembly, transportation and storage. The first electrode tab 61 can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

The shape and size of the battery of the present invention have no visible difference from the shape and size of a conventional battery, but the short circuit protection function of melting is realized, which is safe, reliable and highly practical.

### Eighth Embodiment

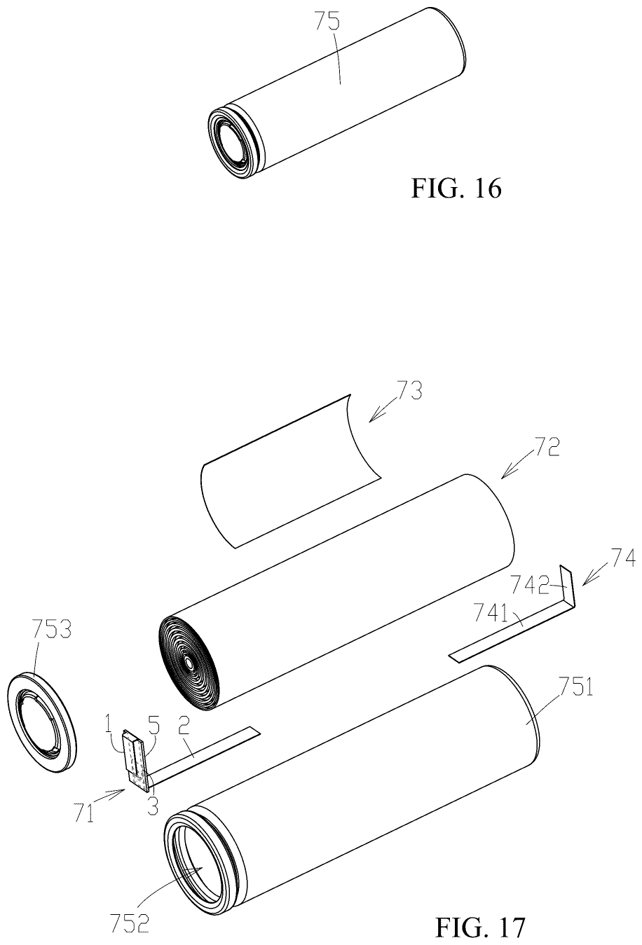

Please refer to FIGS. 16 and 17, a battery with a cylindrical shape in accordance with an eighth embodiment of the present invention is illustrated. The battery is a hard-packaged battery, such as a 18650 type battery. The battery at least includes a first electrode tab 71, a second electrode tab 74, a core 72, a termination tape 73, and a pack 75. The first electrode tab 71 has a similar structure to that in the first embodiment. The second electrode tab 74 includes a rectangular metal sheet and is a common battery tab.

The core 72 may include a positive electrode plate, a first separator, a negative electrode plate and a second separator which are stacked one by one then rolled into a cylindrical jellyroll. The positive electrode plate may include a metal sheet, e.g., aluminum foil, upon which positive electrode material or electrode active mix spread in conventional manner. The negative electrode plate may include a metal sheet, e.g., copper foil, upon which negative electrode material or electrode active mix spread in conventional manner. The pack 75 is a steel case including a can 751 having an opening 752 and a cover 753 covering the can 751 to seal the opening 752. A liquid electrolyte may be filled in the pack 75 to provide ionic conductivity. The liquid electrolyte generally includes an electrolytic salt dissolved in a solvent, i.e. an inorganic solvent or an organic solvent. In other embodiments, solid electrolyte, or polymer or gel electrolyte may be used to replace the liquid electrolyte.

The termination tape 73 is attached to a surface of the core 72. The termination tape 73 is an insulating tape and is at least used to prevent the core 72 from being unwound.

The first electrode tab 71 is connected to one of the positive electrode plate and the negative electrode plate of the core 72. In detail, a part of the second metal strip 2 is inserted in the core 72 to connected to one of the positive electrode plate and the negative electrode plate of the core 72, and the other part of the second metal strip 2 is bent to close to an end of the core 72 and is connected to the metal connector 3. The first metal strip 1 is bent into a substantially U shape, its one end is electrically connected to an inner surface (facing an inner space of the can 751) of the cover 753, and the other end is connected to the metal connector 3. The reinforcing structure 5 covers the other end of the first metal strip 1, the metal connector 3 and the other part of the second metal strip 2. The material of the first metal strip 1 and the second metal strip 2 may be chosen from, but not limited to, copper, copper plating nickel, aluminum, stainless steel, iron, silver, etc.

A part 741 of the second electrode tab 74 is inserted in the core 72 to connected to the other one of the positive electrode plate and the negative electrode plate of the core 72, and the other part 742 of the second electrode tab 74 bents to attach or close to the other end of the core 72. The other part 742 is electrically connected to a bottom of the can 751. The material of the second electrode tab 74 may be chosen from, but not limited to, copper, copper plating nickel, aluminum, stainless steel, iron, silver, etc.

Therefore, in the embodiment, the first electrode tab 71 and the second electrode tab 74 are all received in the pack 75. Similar to the seventh embodiment, the metal connector 3 is completely embedded in the battery, and the pack 75 seals and protects the first and second electrode tabs 71, 74. The metal connector 3 has no exposed part, and the relatively vulnerable metal connector is well protected, so as to improve the reliability thereof.

Compared with the traditional plug-in modes of PTC and TCO, the battery has the advantages of regular shape, which are not only easy to install and assemble, saving assembly costs, but also not easy to be damaged in the process of assembly, transportation and storage. The first electrode tab 71 can perfectly solve the short-circuit safety problem without adding any electronic circuit and without changing the shape and size of the battery. It has the characteristics of low cost, high reliability, ultra-thin and ultra-micro structure, etc. The manufacturer of the product using the battery with this electrode tab can greatly improve the safety of the battery without increasing any processing cost and space size, and has high practicality.

The shape and size of the battery of the present invention have no visible difference from the shape and size of a conventional battery, but the short circuit protection function of melting is realized, which is safe, reliable and highly practical.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. An electrode tab, comprising:
a first metal strip; and
a metal connector with one end connected to one end of the first metal strip;
wherein a melting point of the metal connector is lower than a melting point of the first metal strip, or a solidus temperature of the metal connector is lower than a solidus temperature of the first metal strip, or a liquidus temperature of the metal connector is lower than a liquidus temperature of the first metal strip.

2. The electrode tab according to claim 1, wherein both the first metal strip and the metal connector are in sheet shape.

3. The electrode tab according to claim 1, further comprising:
a second metal strip with one end connected to another end of the metal connector;
wherein the metal connector has a lower melting point than that of the second metal strip, or has a lower solidus temperature than that of the second metal strip, or has a lower liquidus temperature than that of the second metal strip;
wherein there is a space between adjacent ends of the first metal strip and the second metal strip.

4. The electrode tab according to claim 3, wherein a connection method for connecting the metal connector to the first metal strip and the second metal strip comprises any one of laser welding, ultrasonic welding, resistance welding, HOTBAR welding, bond welding, conductive adhesive bonding.

5. The electrode tab according to claim 3, further comprising:
a reinforcing structure wrapped around a connection part of the metal connector and the first metal strip and a connection part of the metal connector and the second metal strip for increasing a connection strength.

6. The electrode tab according to claim 5, further comprising:
a tab glue tape wrapped around the second metal strip for immediate hot sealing;
wherein the reinforcing structure comprises a tab glue tape or a seal belt for common sealing.

7. The electrode tab according to claim 5, wherein the tab glue tape comprises any one of DNP black glue, embossed white glue, PP glue, resin, Teflon; the tab glue tape covers the second metal strip by heat sealing; the seal belt comprises any one of DNP black glue, embossed white glue, PP glue, resin, Teflon glue; the seal belt covers a connection region of the metal connector with the first metal strip and the second metal strip by heat sealing, and a heat sealing temperature of the seal belt is lower than a heat sealing temperature of the tab glue tape.

8. The electrode tab according to claim 7, wherein a portion of the tab glue tape is wrapped by the seal belt.

9. The electrode tab according to claim 1, wherein the metal connector is made from any one of tin, tin alloys, aluminum, aluminum alloys, wood's alloys, indium tin alloys, bismuth tin alloys.

10. A battery, comprising:
a core;
a pack defining a receiving space configured for receiving the core;
a first electrode tab with one end connected to the core; and
a second electrode tab with one end connected to the core;
wherein the first electrode tab comprises:
a first metal strip; and
a metal connector with one end connected to one end of the first metal strip;
wherein a melting point of the metal connector is lower than a melting point of the first metal strip, or a solidus temperature of the metal connector is lower than a solidus temperature of the first metal strip, or a liquidus temperature of the metal connector is lower than a liquidus temperature of the first metal strip;
wherein one of the other ends of the first metal strip and the metal connector is configured to be connected to the core.

11. The battery according to claim 10, wherein the other ends of the first electrode tab and the second electrode tab protrude out of the pack.

12. The battery according to claim 10, wherein both the first metal strip and the metal connector are in sheet shape.

13. The battery according to claim 10, where the first electrode tab further comprises:
a second metal strip with one end connected to the other end of the metal connector;
wherein the metal connector has a lower melting point than that of the second metal strip, or has a lower solidus temperature than that of the second metal strip, or has a lower liquidus temperature than that of the second metal strip;
wherein one of the other ends of the first metal strip and the second metal strip is configured to be connected to the core.

14. The battery according to claim 13, wherein a connection method for connecting the metal connector to the first metal strip and the second metal strip comprises any one of laser welding, ultrasonic welding, resistance welding, HOTBAR welding, bond welding, conductive adhesive bonding.

15. The battery according to claim 13, wherein the first electrode tab further comprises:
a reinforcing structure wrapped around a connection part of the metal connector and the first metal strip and a connection part of the metal connector and the second metal strip for increasing a connection strength.

16. The battery according to claim 15, wherein the first electrode tab further comprises a tab glue tape wrapped around the second metal strip for immediate hot sealing the pack; the reinforcing structure comprises a tab glue tape or a seal belt for common sealing.

17. The battery according to claim 15, wherein the tab glue tape comprises any one of DNP black glue, embossed white glue, PP glue, resin, Teflon; the tab glue tape covers the second metal strip by heat sealing; the seal belt comprises any one of DNP black glue, embossed white glue, PP glue, resin, Teflon glue; the seal belt covers a connection region of the metal connector with the first metal strip and the second metal strip by heat sealing, and a heat sealing temperature of the seal belt is lower than a heat sealing temperature of the tab glue tape.

18. The battery according to claim 17, wherein a portion of the tab glue tape is wrapped by the seal belt.

19. The battery according to claim 10, wherein the metal connector is made from any one of tin, tin alloys, aluminum, aluminum alloys, wood's alloys, indium tin alloys, bismuth tin alloys.
